(19) United States
(12) Patent Application Publication
(10) Pub. No.: US 2025/0117250 A1
(43) Pub. Date: Apr. 10, 2025

(54) PROCESSOR UNIT SCHEDULING BASED ON DIE PLAN IN MULTI-CLUSTER ARCHITECTURES

(71) Applicant: QUALCOMM Incorporated, San Diego, CA (US)

(72) Inventors: Rajashekar ADI, Medak (IN); Deevana Murthy BANDARU, Hyderabad (IN)

(21) Appl. No.: 18/483,068

(22) Filed: Oct. 9, 2023

(51) Int. Cl. G06F 9/48; G06F 9/445

(52) U.S. Cl. CPC G06F 9/4881; G06F 9/44505

(57) ABSTRACT

Certain aspects of the present disclosure are directed towards a method for process scheduling. The method generally includes selecting a first processing unit of a plurality of processing units to process a thread based on a use case associated with the thread and locations of the plurality of processing units within an electronic device, and allocating the thread to be processed on the first processing unit.

### TECHNICAL FIELD

Certain aspects of the present disclosure generally relate to electronic circuits and, more particularly, to scheduling threads for processing via processing units.

### BACKGROUND

Thermal issues are a major concern in the realm of computer hardware. The drive for faster and more powerful computers causes thermal issues to become more of a concern. As processors and graphics cards work to execute tasks with increasing complexity, they generate more heat. The heat can lead to reduced performance and hardware failures if not effectively managed. The balance between processing power and thermal control remains a central challenge in computing technologies.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards a method for process scheduling. The method generally includes selecting a first processing unit of a plurality of processing units to process a thread based on a use case associated with the thread and locations of the plurality of processing units within an electronic device, and allocating the thread to be processed on the first processing unit.

Certain aspects of the present disclosure are directed towards an apparatus for process scheduling, comprising a memory and one or more processors coupled to the memory, the one or more processors being configured to: select a first processing unit of a plurality of processing units to process a thread based on a use case associated with the thread and locations of the plurality of processing units within an electronic device; and allocate the thread to be processed on the first processing unit.

Certain aspects of the present disclosure are directed towards a computer-readable medium having instructions stored thereon, that when executed by one or more processors, cause the one or more processors to: select a first processing unit of a plurality of processing units to process a thread based on a use case associated with the thread and locations of the plurality of processing units within an electronic device; and allocate the thread to be processed on the first processing unit.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an example device, in which aspects of the present disclosure may be practiced.

FIG. 2 illustrates a system-on-chip (SOC) including performance clusters.

FIG. 3 illustrates a scheduler assigning thresholds to a performance cluster, in accordance with certain aspects of the present disclosure.

FIG. 4 is a flow diagram illustrating example operations for task scheduling, in accordance with certain aspects of the present disclosure.

FIG. 5 is a flow diagram illustrating example operations for process scheduling, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for scheduling tasks for processing by processing units. In some aspects, the scheduling of tasks (e.g., threads) for processing may be based on a use case associated with the threads and a die plan of a system-on-chip (SOC) including the processing units. Based on the use case, a scheduler may identify a heat source in the SOC. For instance, for a gaming use case, the scheduler may identify that a graphical processing unit (GPU) may be a major heat source as the GPU performs graphic processing for the game. Thus, where there are multiple processing units (e.g., clusters) in the SOC to which the thread may be assigned for processing, the scheduler may select the processing unit that is farther away from the GPU, reducing the thermal impact on the processing of the threads. Certain aspects of the present disclosure reduce performance degradation due to thermal issues when processing tasks (e.g., threads), increasing computing efficiency.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatuses, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

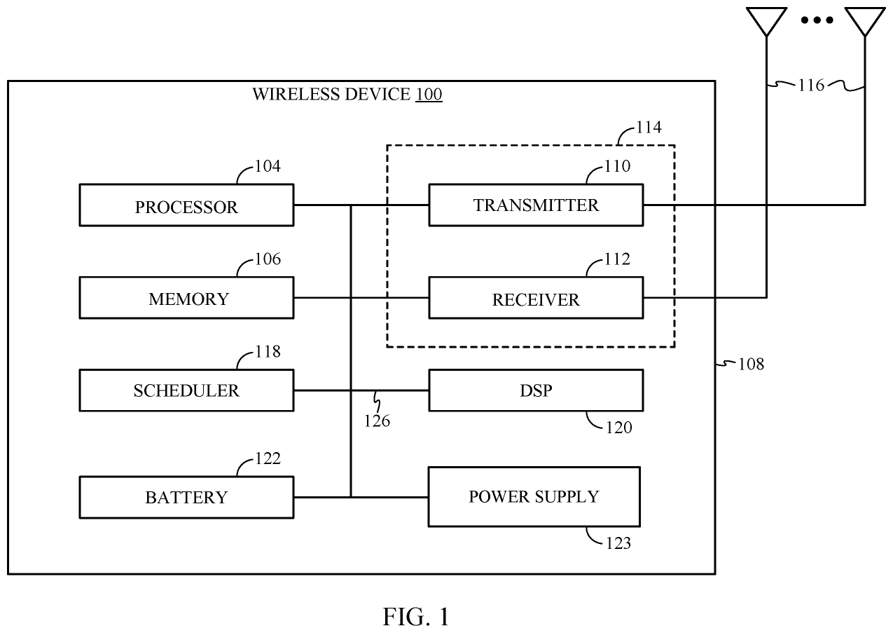

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, a virtual reality (VR) or augmented reality (AR) device, etc.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a scheduler 118 that may be used schedule threads to be processed via one or more processing units of the device 100. In some aspects, the threads may be assigned based on a use case associated with the threads and die configuration, as described in more detail herein. The device 100 may also include a digital signal processor (DSP) 120 for use in processing signals.

The device 100 may further include a battery 122, which may be used to power the various components of the device 100 (e.g., when the device is disconnected from an external power source). The device 100 may also include a power supply system 123 for managing the power from the battery (or from one or more power ports for receiving external power) to the various components of the device 100. At least a portion of the power supply system 123 may be implemented in one or more power management integrated circuits (power management ICs or PMICs) The power supply system 123 may perform a variety of functions for the device 100 such as DC-to-DC conversion, battery charging, power-source selection, voltage scaling, power sequencing, etc.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Techniques for Process Scheduling

In some architectures, threads may be scheduled to run on relatively smaller cores meant to save power (e.g., referred to herein as “power cores”) and some threads may be scheduled to run on relatively bigger cores providing greater performance (e.g., referred to herein as “performance cores”). Generally, low-workload threads run on power cores and high-workload threads tend to run on one or more performance cores (e.g., performance clusters) as the central processing unit (CPU) scheduler schedules the threads in this manner to reduce power consumption and performance. Traditionally, task placement of a scheduler may be based on CPU capacity and task load.

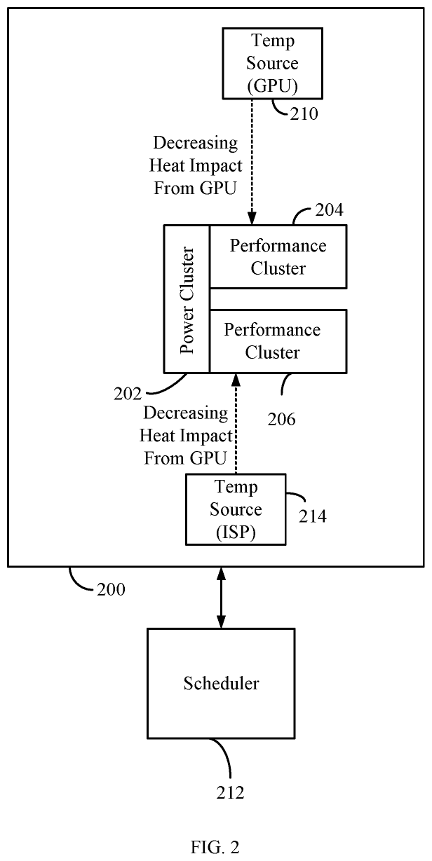

FIG. 2 illustrates a system-on-chip (SOC) 200. The SOC 200 may have multiple clusters of the same performance. For example, the SOC may have multiple performance clusters. In some implementations, there may be one power cluster 202 and two performance clusters 204, 206. The performance clusters 204, 206 may have the same specification and configuration in some cases. Current CPU schedulers (e.g., scheduler 212) place each thread based on the task load and available CPU resources in any of the available two performance clusters. The scheduler also takes into consideration whether there is any thermal pressure for the performance cluster (e.g., whether the temperature for the performance cluster has reached some threshold). If any thermal thresholds are reached, thermal mitigation may be performed to lower the frequencies of the CPUs of the performance clusters or turn off the CPUs altogether in some cases.

The scheduler 212 may not know where the performance clusters 204, 206 are located on the SOC 200. The scheduler 212 knows that there are two performance clusters and schedules the tasks/threads. Thermal throttling of that particular cluster is done at a later point once thermal limits are reached.

To facilitate understanding, suppose a scheduler is assigning threads to clusters for gaming. Games consume high computing power both from the CPU and the GPU. The scheduler 212 identifies the gaming threads as high compute threads and schedules the threads on available performance cluster cores. But as shown in FIG. 2, one of the performance clusters may be beside a heat source, which for gaming, may be the GPU 210 of the SOC that is performing the graphical processing for the game. As shown, the GPU 210 heats up due to the game rendering workload. As the GPU 210 heats up, the heat is spread to the GPU's surroundings on the SOC. The temperature impact from the GPU 210 decreases at locations further away from the GPU. Since the performance cluster 204 is closer to the GPU than the performance cluster 206, the cluster 204 is more greatly impacted by the heat from the GPU 210. If the game thread is running on the performance cluster 204 that is closer to the GPU 210, the performance cluster 204 may heat up and reach thermal thresholds faster as there is already heat spreading from the neighborhood GPU.

While gaming is provided as one example use case, the aspects of the present disclosure are applicable to any suitable use case. For example, a similar problem occurs in other use cases like camera video decoding. Suppose a high-definition (HD) 60 frames per second (fps) video is being processed where the camera image signal processor (ISP) 214 tends to heat up and the scheduler 212 camera threads on the performance cluster 206 closest to the ISP. Then the cluster 206 may reach thermal thresholds faster due to the cluster's proximity to the ISP 214. Thus, when scheduling a thread for the first time without prior knowledge of a performance cluster that will tend to overheat more than another performance cluster (e.g., since one performance cluster is closer to a GPU or ISP than another), the scheduling may not be efficient.

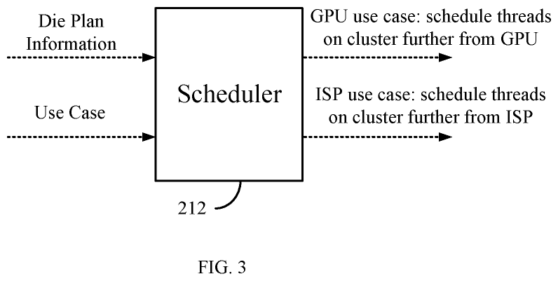

FIG. 3 illustrates a scheduler 212 assigning thresholds to a performance cluster, in accordance with certain aspects of the present disclosure. The scheduler 212 may receive information regarding a preferred cluster while assigning a task on the CPU of that cluster. For example, the scheduler 212 may receive information related to a die plan of the SOC and the associated use case. For example, the die plan information may indicate locations of the clusters on the SOC, or indicate which clusters are closer to heat sources such as the GPU or ISP. In some aspects, the scheduler 212 may maintain a configuration on the device for each type of SOC, including information about neighboring subsystems (e.g., GPU or ISP) for each CPU cluster. Thus, when scheduling threads on a cluster of a particular SOC, the scheduler 212 may use the die plan information maintained for the SOC.

As shown, when a game is being processed, the scheduler 212 may place the tasks/threads on the performance cluster farther away from GPU. Similarly, for camera processing, the scheduler 212 may assign the tasks/threads on the performance cluster that is farther away from the camera ISP. Certain aspects reduce the thermal mitigations as the CPU cores have less overall heat than those closer to the GPU or ISP. Even if any thermal thresholds are reached, it takes longer to reach such thresholds than if the threads are placed on a CPU cluster closer to the GPU or ISP.

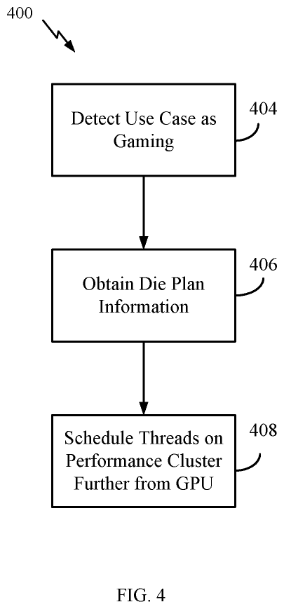

FIG. 4 is a flow diagram illustrating example operations 400 for task scheduling, in accordance with certain aspects of the present disclosure. The operations 400 may be performed, for example, by a schedule such as the scheduler 212.

In some aspects, a game may begin where threads are to be scheduled for the game. At block 404, the scheduler may identify a use case associated with the threads to be scheduled. For instance, the scheduler may identify that the use case associated with the threads is gaming which uses a GPU for graphical processing. At block 406, the scheduler may obtain die plan information for an SOC including performance clusters to be used for processing the threads. At block 408, using the die plan and based on the use case being for gaming, the scheduler may schedule threads on a performance cluster further from the GPU.

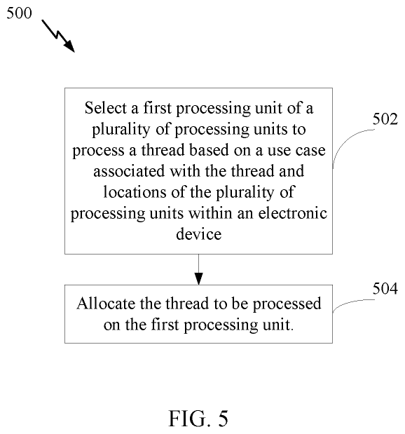

FIG. 5 is a flow diagram illustrating example operations 500 for process scheduling, in accordance with certain aspects of the present disclosure. The operations 500 may be performed by a scheduler such as the scheduler 212.

At block 502, the scheduler selects a first processing unit of a plurality of processing units (e.g., a plurality of performance clusters of an SOC) to process a thread based on a use case associated with the thread and locations of the plurality of processing units within an electronic device. For example, the first processing unit may be selected based on a proximity of each of the plurality of processing units to a data processing unit associated with the use case. The first processing unit may be selected based on the first processing unit being further away from the data processing unit than at least a second processing unit of the plurality of processing units

In some aspects, the first processing unit (e.g., performance cluster 204) may be selected based on the use case being a gaming use case and based on the first processing unit being farther away from a GPU (e.g., GPU 210) of than at least a second processing unit (e.g., performance cluster 206) of the plurality of processing units. In some aspects, the first processing unit (e.g., performance cluster 206) may be selected based on the use case being a video processing use case and based on the first processing unit being farther away from an ISP (e.g., ISP 214) than at least a second processing unit (e.g., performance cluster 204) of the plurality of processing units

In some aspects, the scheduler may identify a type of die including the plurality of processing units. The schedule may identify a configuration of the die based on the type. The configuration may indicate the locations of the plurality of processing units. At block 504, the scheduler allocates the thread to be processed on the first processing unit.

### Example Aspects

In addition to the various aspects described above, specific combinations of aspects are within the scope of the disclosure, some of which are detailed below:

Aspect 1: A method for process scheduling, comprising: selecting a first processing unit of a plurality of processing units to process a thread based on a use case associated with the thread and locations of the plurality of processing units within an electronic device; and allocating the thread to be processed on the first processing unit.

Aspect 2: The method of Aspect 1, wherein the first processing unit is selected based on a proximity of each of the plurality of processing units to a data processing unit associated with the use case.

Aspect 3: The method of Aspect 2, wherein the first processing unit is selected based on the first processing unit being further away from the data processing unit than at least a second processing unit of the plurality of processing units.

Aspect 4: The method according to any of Aspects 1-3, wherein the first processing unit is selected based on the use case being a gaming use case and based on the first processing unit being farther away from a graphical processing unit (GPU) than at least a second processing unit of the plurality of processing units.

Aspect 5: The method according to any of Aspects 1-4, wherein the first processing unit is selected based on the use case being a video processing use case and based on the first processing unit being farther away from an image signal processor (ISP) than at least a second processing unit of the plurality of processing units.

Aspect 6: The method according to any of Aspects 1-5, wherein the plurality of processing units comprises a plurality of performance clusters.

Aspect 7: The method according to any of Aspects 1-6, further comprising: identifying a type of die including the plurality of processing units; and identifying a configuration of the die based on the type, wherein configuration indicates the locations of the plurality of processing units.

Aspect 8: The method according to any of Aspects 1-7, wherein the plurality of processing units are on a system-on-chip (SOC).

Aspect 9: An apparatus for process scheduling, comprising: a memory; and one or more processors coupled to the memory, the one or more processors being configured to: select a first processing unit of a plurality of processing units to process a thread based on a use case associated with the thread and locations of the plurality of processing units within an electronic device; and allocate the thread to be processed on the first processing unit.

Aspect 10: The apparatus of Aspect 9, wherein the one or more processors are configured to select the first processing unit based on a proximity of each of the plurality of processing units to a data processing unit associated with the use case.

Aspect 11: The apparatus of Aspect 10, wherein the one or more processors are configured to select the first processing unit based on the first processing unit being farther away from the data processing unit than at least a second processing unit of the plurality of processing units.

Aspect 12: The apparatus according to any of Aspects 9-11, wherein the one or more processors are configured to select the first processing unit based on the use case being a gaming use case and based on the first processing unit being farther away from a graphical processing unit (GPU) than at least a second processing unit of the plurality of processing units.

Aspect 13: The apparatus according to any of Aspects 9-12, wherein the one or more processors are configured to select the first processing unit based on the use case being a video processing use case and based on the first processing unit being further away from an image signal processor (ISP) than at least a second processing unit of the plurality of processing units.

Aspect 14: The apparatus according to any of Aspects 9-13, wherein the plurality of processing units comprises a plurality of performance clusters.

Aspect 15: The apparatus according to any of Aspects 9-14, wherein the one or more processors are further configured to: identify a type of die including the plurality of processing units; and identify a configuration of the die based on the type, wherein configuration indicates the locations of the plurality of processing units.

Aspect 16: The apparatus according to any of Aspects 9-15, wherein the plurality of processing units are on a system-on-chip (SOC).

Aspect 17: A non-transitory computer-readable medium having instructions stored thereon, that when executed by one or more processors, cause the one or more processors to: select a first processing unit of a plurality of processing units to process a thread based on a use case associated with the thread and locations of the plurality of processing units within an electronic device; and allocate the thread to be processed on the first processing unit.

Aspect 18: The non-transitory computer-readable medium of Aspect 17, wherein the instructions cause the one or more processors to select the first processing unit based on a proximity of each of the plurality of processing units to a data processing unit associated with the use case.

Aspect 19: The non-transitory computer-readable medium of Aspect 18, wherein the instructions cause the one or more processors to select the first processing unit based on the first processing unit being further away from the data processing unit than at least a second processing unit of the plurality of processing units.

Aspect 20: The non-transitory computer-readable medium according to any of Aspects 17-19, wherein the instructions cause the one or more processors to select the first processing unit based on the use case being a gaming use case and based on the first processing unit being farther away from a graphical processing unit (GPU) than at least a second processing unit of the plurality of processing units.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation, and details of the methods and apparatus described above without departing from the scope of the claims.

What is claimed is:

1. A method for process scheduling, comprising:
selecting a first processing unit of a plurality of processing units to process a thread based on a use case associated with the thread and locations of the plurality of processing units within an electronic device; and
allocating the thread to be processed on the first processing unit.

2. The method of claim 1, wherein the first processing unit is selected based on a proximity of each of the plurality of processing units to a data processing unit associated with the use case.

3. The method of claim 2, wherein the first processing unit is selected based on the first processing unit being further away from the data processing unit than at least a second processing unit of the plurality of processing units.

4. The method of claim 1, wherein the first processing unit is selected based on the use case being a gaming use case and based on the first processing unit being farther away from a graphical processing unit (GPU) than at least a second processing unit of the plurality of processing units.

5. The method of claim 1, wherein the first processing unit is selected based on the use case being a video processing use case and based on the first processing unit being farther away from an image signal processor (ISP) than at least a second processing unit of the plurality of processing units.

6. The method of claim 1, wherein the plurality of processing units comprises a plurality of performance clusters.

7. The method of claim 1, further comprising:
identifying a type of die including the plurality of processing units; and
identifying a configuration of the die based on the type, wherein configuration indicates the locations of the plurality of processing units.

8. The method of claim 1, wherein the plurality of processing units are on a system-on-chip (SOC).

9. An apparatus for process scheduling, comprising:
a memory; and
one or more processors coupled to the memory, the one or more processors being configured to:
select a first processing unit of a plurality of processing units to process a thread based on a use case associated with the thread and locations of the plurality of processing units within an electronic device; and
allocate the thread to be processed on the first processing unit.

10. The apparatus of claim 9, wherein the one or more processors are configured to select the first processing unit based on a proximity of each of the plurality of processing units to a data processing unit associated with the use case.

11. The apparatus of claim 10, wherein the one or more processors are configured to select the first processing unit based on the first processing unit being farther away from the data processing unit than at least a second processing unit of the plurality of processing units.

12. The apparatus of claim 9, wherein the one or more processors are configured to select the first processing unit based on the use case being a gaming use case and based on the first processing unit being farther away from a graphical processing unit (GPU) than at least a second processing unit of the plurality of processing units.

13. The apparatus of claim 9, wherein the one or more processors are configured to select the first processing unit based on the use case being a video processing use case and based on the first processing unit being further away from an image signal processor (ISP) than at least a second processing unit of the plurality of processing units.

14. The apparatus of claim 9, wherein the plurality of processing units comprises a plurality of performance clusters.

15. The apparatus of claim 9, wherein the one or more processors are further configured to:
identify a type of die including the plurality of processing units; and
identify a configuration of the die based on the type, wherein configuration indicates the locations of the plurality of processing units.

16. The apparatus of claim 9, wherein the plurality of processing units are on a system-on-chip (SOC).

17. A non-transitory computer-readable medium having instructions stored thereon, that when executed by one or more processors, cause the one or more processors to:
select a first processing unit of a plurality of processing units to process a thread based on a use case associated with the thread and locations of the plurality of processing units within an electronic device; and
allocate the thread to be processed on the first processing unit.

18. The non-transitory computer-readable medium of claim 17, wherein the instructions cause the one or more processors to select the first processing unit based on a proximity of each of the plurality of processing units to a data processing unit associated with the use case.

19. The non-transitory computer-readable medium of claim 18, wherein the instructions cause the one or more processors to select the first processing unit based on the first processing unit being further away from the data processing unit than at least a second processing unit of the plurality of processing units.

20. The non-transitory computer-readable medium of claim 17, wherein the instructions cause the one or more processors to select the first processing unit based on the use case being a gaming use case and based on the first processing unit being farther away from a graphical processing unit (GPU) than at least a second processing unit of the plurality of processing units.
